(19) United States
(12) Patent Application Publication
(10) Pub. No.: US 2012/0024622 A1
(43) Pub. Date: Feb. 2, 2012

(54) Gaseous-fluid supply system for noise abatement application

(76) Inventor: Yen Tuan, Kirkland, WA (US)

(21) Appl. No.: 13/135,875

(22) Filed: Jul. 18, 2011

Related U.S. Application Data
(60) Provisional application No. 61/400,697, filed on Aug. 2, 2010.

(51) Int. Cl. B64D 33/02

(52) U.S. Cl. 181/214

(57) ABSTRACT

Gaseous-fluid supply system for a general industrial power machinery application and a class of laboratory noise research and development comprises three subsystems, namely a gaseous-fluid delivery subsystem, a gaseous-fluid settling subsystem and a gaseous-fluid duct subsystem. Each subsystem must satisfy a set of fluid dynamic requirements determined by the situation in hand. For noise abatement application and research, an addition set of self-noise requirements must also be satisfied.

An embodiment of a quiet air supply device for an aviation fan engine inlet noise abatement application using tangential blowing is also described. Acoustic treatment of the quiet air supply device is such that the self-noise of the supply air is low. The fluid dynamic quality of the supply air is such that the tangential blowing would not cause the aviation fan engine inlet noise source to increase.

The self-noise floor of the supply air as a result of the acoustic treatment of the air supply device is made lower that the inlet noise so that the full potential of inlet noise abatement by tangential blowing may be realized.

The features of the quiet air supply device can be readily streamlined and compacted for an air worthy aviation fan engine inlet noise control application.

### BACKGROUND OF THE INVENTION

Industrial power sources, such as internal combustion engine, turbo-machinery and aviation turbo-fan engine often involve air flows. These air flows generate noise that propagates out of these power machineries and impresses upon the environment in which they operate and causes annoyance in the neighborhood communities.

In particular, aviation engines have been the source of noise pollution in the airport communities and this noise pollution has been the target of abatement in the past 40 years.

To reduce the power machinery noise in general and aviation engine noise in particular, one of the effective methods is to introduce recirculation flows into the main air flow of the machinery such as the tangential blowing flows in a U.S. Pat. No. 7,967,105, Jun. 28, 2011, entitled “Aero-acoustic aviation engine inlet for aggressive noise abatement” and a patent application entitled “Aviation engine inlet with tangent blowing for buzz saw noise control, submitted Jul. 7, 2011.”

These recirculation flows are invariably ducted into the main flow of the machinery from some external air sources. For stationary power machinery, the recirculation air source could be from the plant air system. For aviation engine, the recirculation air flow could be from on-board auxiliary power unit or from air bleed of the engine fan flow.

In all cases, the self-noise of the recirculation air flow must be lower than that of the power machinery. To render a low self-noise of the recirculation air flow, the air supply system must be noise treated.

### BRIEF SUMMARY OF THE INVENTION

This disclosure presents a quiet gaseous-fluid supply system for a general industrial application, comprising a quiet gaseous-fluid settling chamber subsystem, a gaseous-fluid delivery subsystem and an inflow duct subsystem connecting to gaseous-fluid sources; and yet, the features of the quiet gaseous-fluid supply system are suitably broad for a class of laboratory noise research and development application. Self-noise level and the fluid dynamic quality of the gaseous-fluid supply system, as predetermined by each specific case, must be satisfied for the objectives of each application.

A quiet air supply device for a laboratory model fan inlet that was built and tested in connection with a noise research program is also described in this disclosure. As a demonstration, the usage and merits of the quiet air supply device is presented in connection with the laboratory model fan inlet tested in an anechoic chamber.

The features of the quiet air supply device can be readily streamlined and compacted for an air worthy aviation fan engine inlet noise control application.

### BRIEF DESCRIPTION OF THE DRAWINGS

There are 7 drawings:

FIG. 1 An aviation engine inlet noise control model test hardware

FIG. 2 Annular blowing slots

FIG. 3 Tangential blowing aka wall jet

FIG. 4 Buzz saw noise frequency spectrum

FIG. 5 Noise test facility

FIG. 6 Quiet air supply device for aviation engine inlet application

FIG. 7 Supply air from engine fan flow or form low-pressure compressor flow passing through hollow fan stator vanes

### DETAILED DESCRIPTION OF THE INVENTION

### Description of a Generic Gaseous-Fluid Supply System for Noise Abatement Application

A generic gaseous-fluid supply system for noise abatement application comprising the following components:

A gaseous-fluid delivery subsystem with specific self-noise threshold and fluid dynamic requirements,
A duct subsystem interfacing with gaseous-fluid sources with specific self-noise and fluid dynamic requirements,
A gaseous-fluid settling chamber subsystem having the following features:
Multiple number of chambers, in which the homogeneity of fluid is to be established,
Arranging the chambers in series with the flow path,
Arranging the chambers in parallel with the flow path,
Arranging the chambers close to the gaseous-fluid deliver subsystem,
Chamber annular in shape or in a C shape, and in wrapping around mode,
On the inside surface of the chambers are installed acoustic lining segments tuned at various frequencies of the noise of the gaseous-fluid sources,
To the inflow end of the chamber opening is installed a high percentage open area perforated plate to reflect the noise back in the upstream flow direction,
Low internal flow resistance and low internal flow noise methods are to be applied.

### Detailed Description of an Embodiment of a Quiet Air Supply Device for Aviation Engine Inlet Noise Abatement Application

An aviation fan engine, including an inlet, is tubular in shape. The inlet serves to guide air into the fan, which through fan rotation adds energy to the air. The high energy air exits the engine fan nozzle, producing propulsion thrust.

Details of an embodiment of a quiet air supply device are disclosed in the following for a general aviation fan engine inlet application. The purpose of the quiet air supply device is to deliver by tangential blowing a recirculation flow of air into the engine inlet that grazes over the inlet interior surface to alleviate the inlet noise of the engine. The requirements of the quiet air supply device are that it must satisfy a low self-noise threshold and that the tangential blowing flow must be of a quality not to cause a noise generation of the engine fan.

The quiet air supply device consists of a quiet air settling chamber, a quiet air delivery slot and an inter-connecting group of tubes.

The low self-noise requirement of the quiet air supply device is not to contaminate the performance of the attenuation of the inlet noise. When the air source itself is at a high noise level, acoustic linings must be applied on the quiet air settling chamber surface to attenuate the noise of the air source. A case in question is that when the air source is the air bled from the main engine fan air flow downstream from the fan rotor. High percent open area perforated plate can be installed in the recirculation air flow path in the air supply device to reflect the air born noise upstream. The components of the quiet air supply device must be constructed such that very little noise would be generated by the recirculation air flow in the components.

The fluid dynamic quality of the recirculation air flow exiting from the quiet air delivery slot, a tangential blowing slot, is that the flow be tangential to the inlet interior surface and that it is uniform in the flow speed at any azimuth angle of the circular inlet all the way 360 degrees around the inlet. This requirement calls for that the quiet air-settling chamber and the tangential blowing slot of the quiet air supply device be annular, axial symmetric all the way 360 degrees around the engine inlet axis. Lacking this fluid dynamic quality in the blowing air flow would increase the fan noise generation, which is contrary to the purpose of the application of the quiet air supply device.

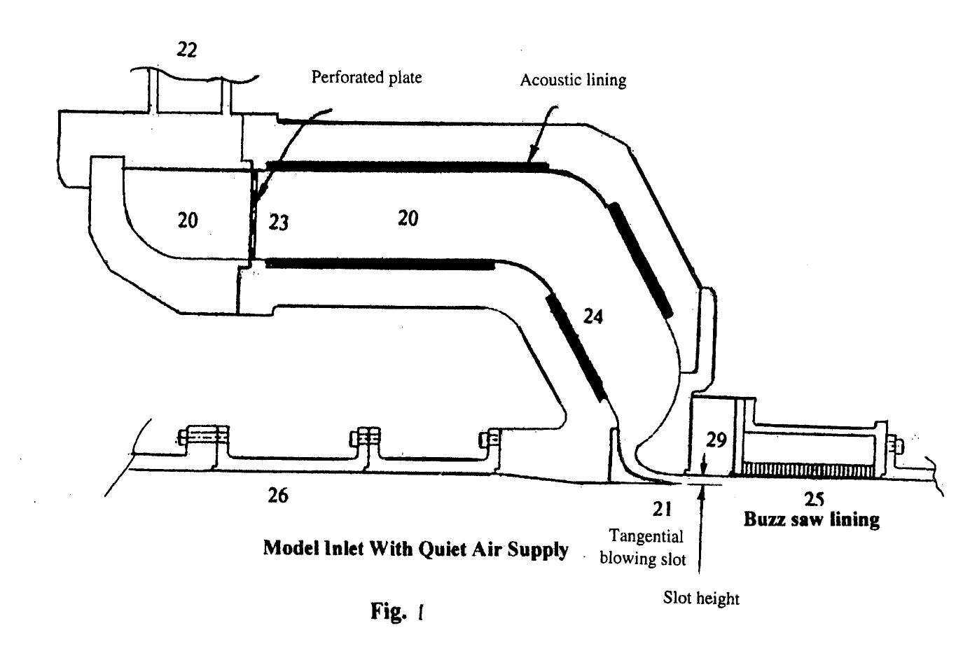

FIG. 1 is an engineering drawing of a model fan inlet for inlet noise control using a quiet air supply device. The quiet air supply device is shown in FIG. 1 having a quiet air-settling chamber, 20, a quiet air delivery slot, 21 which is a tangential blowing slot; the duct segments, 22 are a group of tubes that connects between the air source and the quiet air settling chamber.

The quiet air settling chamber, 20 is annular. On the chamber interior surfaces are four acoustic lining segments, 24. Covering the upstream end of the chamber in-flow opening is a high percent open area perforated plate, 23. These acoustic designs are to reduce the self-noise of the air flowing through the quiet air supply device.

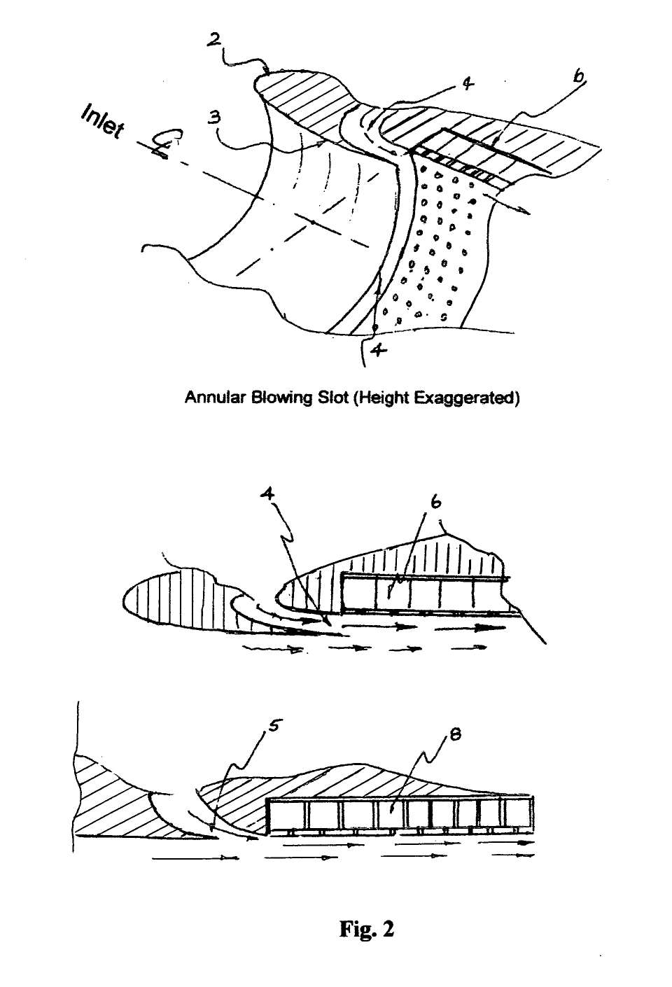

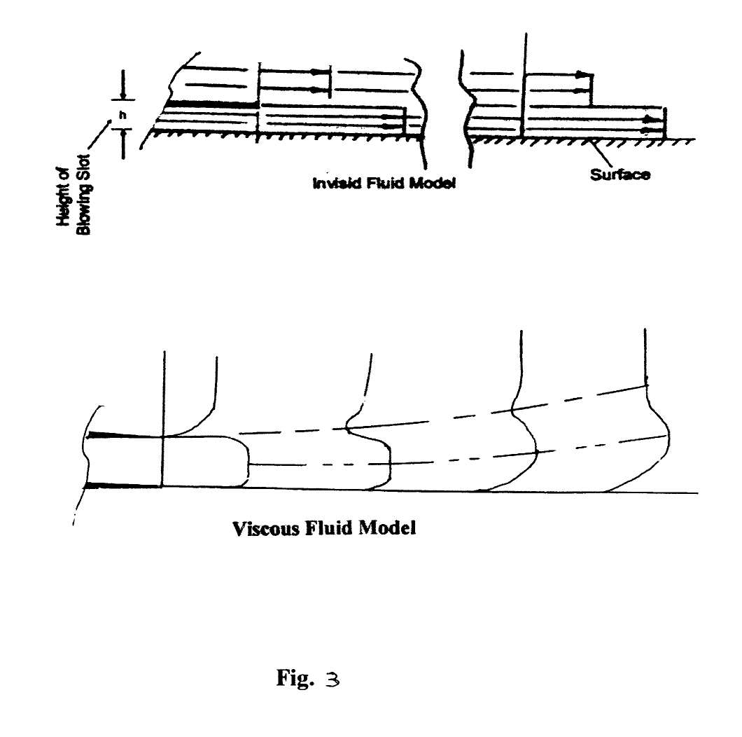

The tangential blowing slot, 21 is also annular (see also FIG. 2, reference number 4) extending axial symmetrically 360 degrees in the circumferential direction all the way around the inlet axis and having a slot lip in the shape of a downstream facing step. The tangential blowing slot, otherwise known as a wall jet slot, is to deliver a stream of blowing air flow grazing along, that is tangent to, a segment of buzz saw lining surface, (FIG. 1, 25), in the present case, see also (FIG. 2, reference numbers 6 and 8). An effective way of delivery of a grazing (tangential) flow is for the blowing slot showing in FIGS. 1 and 2, to have a slot lip in the shape of a down stream facing step. The slot lip can also be flush with the interior surface of the inlet (FIG. 2, reference number 5). A tangential flow situation is shown in FIG. 3. When air viscosity or turbulence is involved, the flow situation is complex (see the reference literature). This grazing flow, a tangential flow, of the blowing air is important, as it creates a flow field downstream over the acoustic lining surface, in the present application, causing a increase in the noise attenuation performance, particularly in the buzz saw noise attenuation performance.

Four tubes (FIG. 1, 22) 90 degree spaced are to supply airflows to the quiet air settling chamber, while the other end of the tubes is connected to the air source.

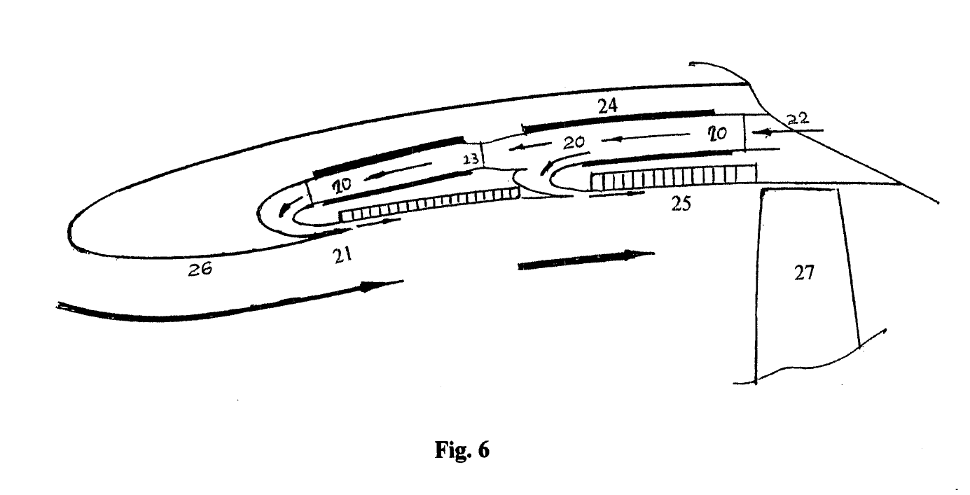

This model experimental hard ware is not for flight application, therefore, the quiet air supply device is oversized. An airworthy layout of the quiet air supply device is shown in FIG. 6, having 2 blowing slots and 2 acoustic lining segments, showing the streamline and the compactness of the quiet air supply device.

An experimental program was executed in dealing with the inlet buzz saw noise, the inlet broadband noise, the inlet fan tone noise and their control. The scope of the experiment program was to evaluate the effects of the flow boundary layer development on the inlet interior surface and the manipulation of the boundary layer flow by tangential blowing on the inlet noise sources and their attenuation.

The slot lip can be positioned immediately upstream from the acoustic lining by removing a section (FIG. 1, 29). This hard wall section is a cylindrical section of the inlet, and is manufactured to be removable so that to determine noise attenuation effect of this hard wall length.

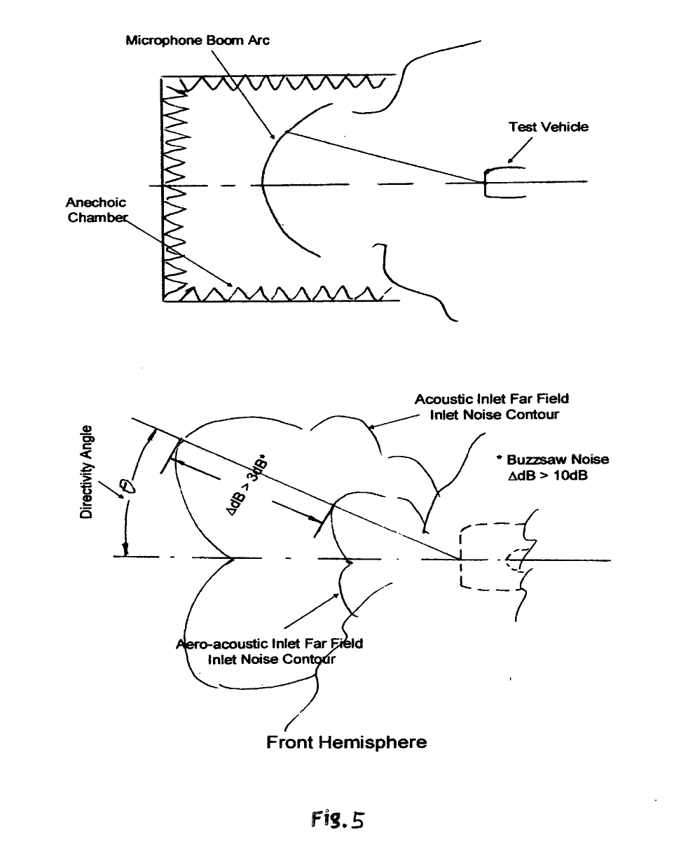

The experiments using the above test vehicle were performed in an anechoic chamber (FIG. 5) in an acoustic laboratory.

The low self-noise of the quiet air supply device is an important factor contributing to the success of the experimentation; and in noise experimentation, there is very little margin between success and failure. The self-noise level of the quiet air supply device serves as a noise floor; should this noise floor be higher than the inlet noise, all the inlet noise will be buried under this noise floor and can not easily be detected. In this case, all the evidences of the inlet noise attenuation efforts will be masked and buried under this noise floor. Fortunately, the quiet air supply device shown in FIG. 1, tested at various blowing speeds with the model fan removed, displays a very low self-noise.

Unexpected results of the improvement of the inlet buzz saw noise attenuation were obtained from these experiments. The improvement of the attenuation was remarkable. And the attenuation frequency bandwidth was also widened by a large magnitude. The results demonstrate a robust inlet buzz saw noise attenuation that can be readily extended to full size engine application without large negative scaling effect. The full magnitudes of the results would not be realized if the self-noise of the blowing air were not effectively reduced by the acoustic design of the quiet air supply device.

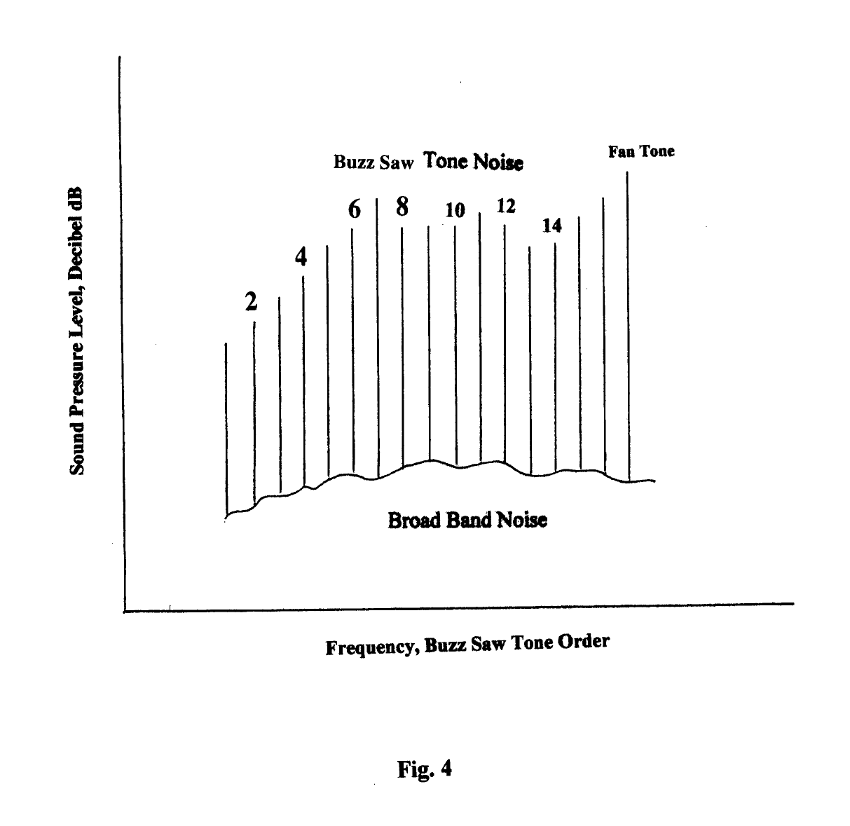

In the anechoic test facility (FIG. 5), the model fan inlet test vehicle was mounted on a test stand, which was placed in the center of the anechoic chamber. Free far field noise emitted from the inlet was measured by a boom-mounted microphone which was able to traverse the full front quadrant from azimuth angles of 0 degree to 90 degrees. The test vehicle was maintained “on-condition” for one minute during which the noise was measured and recorded. The fan was running at a transonic speed when the inlet buzz saw noise was dominant. A copy of the microphone measurements at an azimuth angle of 45 degree was recorded on a CD. A copy of this CD was submitted to USPTO in connection with the Tuan U.S. Pat. No. 7,967,105, Jun. 28, 2011. The measurements were for a back-to-back comparison of the buzz saw noise levels when the blowing air was turned off vs. when the blowing air was turned on, indicating the improvement of the buzz saw lining attenuation performance by the blowing air. Play back of the CD recording provides a marked awareness of the decrease in the buzz saw noise level. Frequency analysis of the test data readily reveals that when the blowing air is turned on, the full range of the buzz saw tones disappear, submerged below the broadband noise floor. A typical hard wall inlet buzz saw noise frequency spectrum is shown in FIG. 4, indicating the prominent buzz saw tones protruding above the broad band noise floor, enabling the exploration of the full potential of the attenuation of the tangential blowing on the buzz saw lining. Should the self-noise floor of the air flow of the quiet air supply device be higher than the inlet broad band noise, the full potential of the attenuation of the buzz saw tones would not be readily measured.

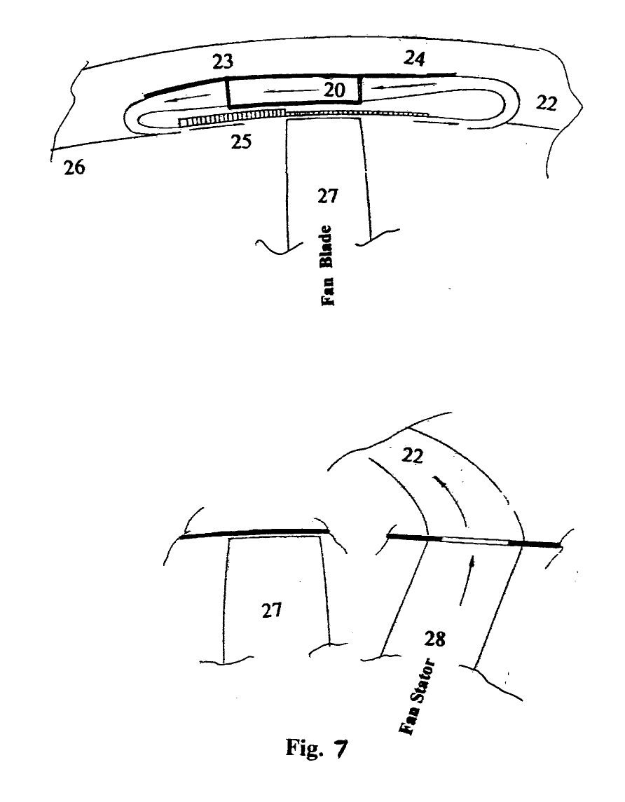

The air source for the quiet air supply device in connection with the test configuration in FIG. 1 was from a plant air system in the acoustic laboratory. Other air sources were under consideration among which was the using of the fan bypass flow air downstream from the fan rotor (FIG. 7). On account that, in the fan bypass flow, the noise behind the fan rotor is high, to duct this air into the inlet is to contaminate the inlet noise by the noise behind the fan rotor, and a “hard wall air supply device” is an efficient noise conduit. Therefore, using the air source from fan bypass flow for inlet noise control by blowing, high noise level of this air source must be dealt with, thus, the quiet air supply device as shown in FIG. 1 is important. The engine primary airflow can also be used as the blowing air source; low-pressure compress bleed air may be used. In this case, the fan exhaust vanes (FIG. 7, 28) may be made hollow so that the low pressure compressor bleed air can pass through the hollow fan exit vans across the fan bypass flow channel and be connected to the quiet air supply device in the cowling cavity. To deal with the noise of these air sources, the quiet air supply device such as shown in FIG. 1 is also important.

### Other Aviation Applications of the Quiet Air Supply System

Other applications of the quiet air supply device are for airplane high lift systems such as augmental wing system and airplane wing upper surface blowing system. These systems are to increase the wing lift at low speed flight such as airplane operations near an airport—a noise restricted area. Therefore, a quiet air supply system, such as in the present disclosure, has multiple important applications.

We claim:

1) A generic gaseous-fluid supply system for a general industrial application and a class of laboratory noise abatement research and development, comprising:
A gaseous-fluid settling subsystem with a geometry, an acoustic treatment, a noise reflecting high percent open area perforated plate and a homogeneity of the gaseous-fluid as required by a specific application in hand,
A gaseous-fluid delivery subsystem with a geometry and a fluid dynamic quality as required be the specific application in hand,
A inter-connecting duct subsystem with a geometry as required be the specific application in hand,
In the gaseous-fluid settling subsystem, the gaseous-fluid delivery subsystem and the inter-connecting duct subsystem, an improvement comprising, a low self-noise level of the delivered gaseous-fluid and a flow uniformity of the delivered gaseous-fluid as required be the specific application in hand.

2) A quiet air supply device for an aviation fan engine inlet noise abatement comprising:
A quiet air settling chamber with a homogeneity of a thermodynamic state of the air inside,
A quiet air delivery slot,
An inter-connecting group of tubes,
In the quiet air settling chamber, the quiet air delivery slot and the inter-connecting group of tubes, an improvement comprising, a lower self-noise level than the inlet noise level of the aviation fan engine and a layer of a tangential blowing flow 360 degrees all the way around the aviation fan engine inlet axis that will not increase the aviation fan engine inlet noise source.

3) The quiet air supply device in claim 2, wherein, the quiet air settling chamber is annular, axial symmetric, 360 degrees all the way around the aviation fan engine inlet axis.

4) The quiet air supply device in claim 2, wherein, the quiet air settling chamber has acoustic lining segments in the inside walls and a high percent open area perforated plate across the inflow of air into the quiet air settling chamber.

5) The quiet air supply device in claim 2, wherein, the quiet air delivery slot geometry is annular, axial symmetric 360 degrees all the way around the aviation fan engine inlet axis.

6) The quiet air delivery slot in claim 5, wherein, the lip of the quiet air delivery slot takes a shape of a downstream facing step.

7) The quiet air delivery slot in claim 5, wherein, the lip of the quiet air delivery slot is flush with the interior surface of the inlet of the aviation fan engine.

8) The quiet air delivery slot in claim 5, wherein, the quiet air delivery slot is positioned immediately upstream from an acoustic lining segment on the interior surface of the aviation fan engine inlet.
